(19) United States
(12) Patent Application Publication
(10) Pub. No.: US 2006/0114243 A1
(43) Pub. Date: Jun. 1, 2006

(54) Switching matrix apparatus for semiconductor characteristic measurement apparatus

(75) Inventor: Katsuhito Iwasaki, Kanagawa (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/290,984

(22) Filed: Nov. 30, 2005

(30) Foreign Application Priority Data
Dec. 1, 2004 (JP) 2004-348283

(51) Int. Cl. G09G 5/00

(52) U.S. Cl. 345/173

(57) ABSTRACT

The switching matrix apparatus is provided with a plurality of relay switches for opening and closing the electrical connections between a plurality of input terminals and a plurality of output terminals, and a display unit in which a plurality of light-emitting portions are arranged in a matrix in correspondence with the respective relay switches and in which indicators indicating the positions of the light-emitting portions in at least multiple columns and rows are displayed along at least two sides of the light-emitting portions arranged in a matrix. In order to facilitate confirmation of the position of a light-emitting portion that is about to be selected or has been selected with a light pen on the display unit, light is emitted by at least one other light-emitting portion relating to the light-emitting portion that is about to be selected or has been selected.

### FIELD OF THE INVENTION

The present invention relates to a switching matrix apparatus for the measurement of semiconductor characteristics. In particular, the present invention relates to an apparatus that clearly indicates the position pointed at with a light pen on a matrix LED display unit.

### BACKGROUND OF THE INVENTION

Conventionally, a switching matrix apparatus is used to easily change the connections between multiple semiconductor-characteristic measurement apparatuses and a device under test (hereinafter referred to as “DUT”). The switching matrix apparatus connects input ports and output channels in arbitrary combinations in accordance with an instruction from a user. In this case, depending on the kind of measurements, one or more semiconductor-characteristic measurement apparatuses, including an LCR (inductance-capacitance-resistance) meter, are connected to the input ports, and a probe apparatus or the like to be connected to the target DUT is connected to the output channels. The input ports and the output channels are connected via relay switches, and the electrical connections between the input ports and the output channels are opened or closed by the relay switches. The opening/closing of each relay switch is specified by the user such that the connection is appropriate for the object of the measurement.

Examples of such a switching matrix include a switching matrix 707A commercially available from Keithley Instruments Inc. For the description of this product, reference is made to the following documents: the catalog of Keithley Instruments Inc., “Keithley's Switching Systems for Switching and Control Solutions for DC, RF, and Light” available from URL: http://www.keithley.com/main.jsp?action=keithleysearch&searchType=view&clic kPath=Document+Center&itemType=brochure&role=&keywords=707A, found on May 17, 2004; and the catalog of Keithley Instruments Inc., “Model 707A, Switching Matrix Mainframe with Fixed Rack Kit”, available from URL: http://www.keithley.com/main.jsp?action=keithleysearch&searchType=view&clic kPath=Document+Center&itemType=data+sheet&role=&keywords=707A, found on May 17, 2004.

This switching matrix product has a display unit that uses LEDs (light-emitting diodes) to indicate which input port and output channel are connected to each other. A light pen can optionally be used with the product. When the tip of the light pen is located on an LED corresponding to the intended relay switch and a button provided on the body of the light pen is pressed, the LED on which the light pen is located is detected. This makes it possible to selectively open and close the corresponding relay switch. The opening/closing of the relay switch is also indicated by the LED turning on or off.

In a conventional switching matrix apparatus, integer display numbers corresponding to the positions of the column lines and the row lines are displayed on an edge of the matrix LED display unit. However, in the conventional apparatus described above, the number of LEDs arranged in a matrix is large, and thus it is difficult for a user to quickly and precisely determine the position currently specified with the light pen and the intended position, based on the display numbers displayed on the edge of the LED display unit. This will become an even more serious problem if the number of switching matrixes increases in future; and thus the density in the LED arrangement inside the LED display unit needs to be increased.

### SUMMARY OF THE INVENTION

In view of the above-described problem, it is an object of the present invention to provide a switching matrix apparatus used for connecting a plurality of input terminals and a plurality of output terminals, with which a user can quickly and precisely switch the connections.

An embodiment of the present invention provides a switching matrix apparatus used for connecting a semiconductor-characteristic measurement apparatus and a device under test, comprising a plurality of input terminals for connection with the semiconductor-characteristic measurement apparatus, a plurality of output terminals for connection with the device under test, a plurality of relay switches that are arranged in a matrix for electrically connecting the input terminals with the output terminals and that are used for opening and closing the electrical connections between the input terminals and the output terminals, a light-emitting-portion matrix in which a plurality of light-emitting portions are arranged in a matrix in correspondence with the respective relay switches and in which indicators of numerals or symbols indicating a position among the light-emitting portions in at least one column and one row are displayed along at least two sides of the light-emitting portions arranged in a matrix, and input means for selecting a relay switch in cooperation with display of the light-emitting portions in the light-emitting-portion matrix. In the switching matrix apparatus, the light emitting portions are selected by the input means, and then a combination of the electrical connections between the plurality of input terminals and the plurality of output terminals is switched by sequentially changing a combination of opening/closing of the plurality of relay switches. In order to facilitate confirmation, based on the indicators, of the position by column and row of a light-emitting portion selected by the input means in the light-emitting-portion matrix, light is emitted by at least one other light-emitting portion relating to the selected light-emitting portion. According to the present invention, while the light-emitting portions may be selected, the relay switches corresponding to light-emitting portions can be specified.

Furthermore, in the present invention, it is preferable that when a light-emitting portion in the light-emitting-portion matrix is selected by the input means, light is emitted by at least multiple other light-emitting portions of the column and the row comprising the light-emitting portion, in the light-emitting-portion matrix.

Furthermore, in the present invention, it is preferable that when a light-emitting portion in the light-emitting-portion matrix is selected by the input means, light is emitted by at least one light-emitting portion present between the selected light-emitting portion and the indicators, among the other light-emitting portions of the column and the row which includes the light-emitting portion, in the light-emitting-portion matrix.

Furthermore, in the present invention, it is preferable that in order to distinguish from light emitted for indicating a status of each of the relay switches, the emitted light color, brightness, or flashing pattern of the selected light-emitting portion is changed from that of the light emitted for indicating the status, in the light-emitting portions in the light-emitting-portion matrix.

Another embodiment of the present invention provides a switching matrix apparatus used for connecting a semiconductor-characteristic measurement apparatus and a device under test, comprising a plurality of input terminals for connection with the semiconductor-characteristic measurement apparatus, a plurality of output terminals for connection with the device under test, a plurality of relay switches that are arranged in a matrix for electrically connecting the input terminals with the output terminals and that are used for opening and closing the electrical connections between the input terminals and the output terminals, a light-emitting-portion matrix in which a plurality of light-emitting portions are arranged in a matrix in correspondence with the respective relay switches, indicator light-emitting portions that are arranged along at least two sides of the light-emitting-portion matrix and that emit light to display indicators of numerals or symbols indicating a position among the light-emitting portions in at least one column and one row, and input means for selecting a relay switch in cooperation with display of the light-emitting portions in the light-emitting-portion matrix. In the switching matrix apparatus, the input means performs selection, and then a combination of the electrical connections between the plurality of input terminals and the plurality of output terminals is switched by sequentially changing a combination of opening/closing of the plurality of relay switches. In order to facilitate confirmation, based on the indicators, of the position by column and row of a light-emitting portion selected by the input means in the light-emitting-portion matrix, light is emitted by the indicator light-emitting portions. When a light-emitting portion in the light-emitting-portion matrix is selected by the input means, it is preferable that light is emitted by the indicator light-emitting portions indicating the column position and the row position of the light-emitting portion.

It is preferable that the input means is a light pen or cursor keys.

Another embodiment of the present invention provides a switching matrix apparatus used for connecting a semiconductor-characteristic measurement apparatus and a device under test, comprising a plurality of input terminals for connection with the semiconductor-characteristic measurement apparatus, a plurality of output terminals for connection with the device under test, a plurality of relay switches that are arranged in a matrix for electrically connecting the input terminals with the output terminals and that are used for opening and closing the electrical connections between the input terminals and the output terminals, a light-emitting-portion matrix in which a plurality of light-emitting portions are arranged in a matrix in correspondence with the respective relay switches and in which indicators of numerals or symbols indicating a position among the light-emitting portions in at least one column and one row are displayed along at least two sides of the light-emitting portions arranged in a matrix, and a light pen for selecting a relay switch in cooperation with display of the light-emitting portions in the light-emitting-portion matrix. This switching matrix apparatus is switched by a successive three stage process consisting of a stage wherein the light-emitting portions are about to be selected by the light pen, a stage wherein the portions are selected, and finally a stage in which the combination of the electrical connections between the plurality of input terminals and the plurality of output terminals is switched by changing the combination of opening/closing of the plurality of relay switches. In order to facilitate confirmation, based on the indicators, of the position by column and row of a light-emitting portion that is about to be selected or has been selected with the light pen in the light-emitting-portion matrix, light is emitted by at least one other light-emitting portion relating to the light-emitting portion that is about to be selected or has been selected. Herein, the term “about to be selected” refers to a state in which the tip of the light pen is on the light-emitting portion, and thus possible to sense light from the light emitting portion, but an operation for the selected position has not been determined yet with, for example, a button on the body of the light pen or a switch on the tip of the light pen. The term “has been selected” refers to a state in which in addition to the “about to be selected” state, the operation of determining the selected position with, for example, a button on the body of the light pen or a switch on the tip of the light pen has been performed.

Furthermore, in the present invention, it is preferable that when a light-emitting portion in the light-emitting-portion matrix is about to be selected or has been selected with the light pen, light is emitted by at least multiple other light-emitting portions of the column and the row comprising the light-emitting portion, in the light-emitting-portion matrix.

Furthermore, in the present invention, it is preferable that when a light-emitting portion in the light-emitting-portion matrix is about to be selected or has been selected with the light pen, light is emitted by at least one light-emitting portions present between the light-emitting portion that is about to be selected or has been selected and the indicators, among the other light-emitting portions of the column and the row comprising the light-emitting portion, in the light-emitting-portion matrix.

Furthermore, in the present invention, it is preferable that in order to distinguish from light emitted for indicating a status of each of the relay switches, the emitted light color, brightness, or flashing pattern of the light-emitting portion that is about to be selected or has been selected is changed from that of the light emitted for indicating the status, in the light-emitting portions in the light-emitting-portion matrix.

Another embodiment of the present invention provides a switching matrix apparatus used for connecting a semiconductor-characteristic measurement apparatus and a device under test, comprising a plurality of input terminals for connection with the semiconductor-characteristic measurement apparatus, a plurality of output terminals for connection with the device under test, a plurality of relay switches that are arranged in a matrix for electrically connecting the input terminals with the output terminals and that are used for opening and closing the electrical connections between the input terminals and the output terminals, a light-emitting-portion matrix in which a plurality of light-emitting portions are arranged in a matrix in correspondence with the respective relay switches, indicator light-emitting portions that are arranged along at least two sides of the light-emitting-portion matrix and that emit light to display indicators of numerals or symbols indicating a position among the light-emitting portions in at least one column and one row, and a light pen for selecting a relay switch in cooperation with display of the light-emitting portions in the light-emitting-portion matrix. This switching matrix apparatus is switched by a successive three stage process consisting of a stage wherein the light-emitting portions are about to be selected by the light pen, a stage wherein the portions are selected, and finally a stage in which the combination of the electrical connections between the plurality of input terminals and the plurality of output terminals is switched by changing the combination of opening/closing of the plurality of relay switches. In order to facilitate confirmation, based on the indicators, of the position by column and row of a light-emitting portion that is about to be selected or has been selected with the light pen in the light-emitting-portion matrix, light is emitted by some indicator light-emitting portions. When a light-emitting portion in the light-emitting-portion matrix is about to be selected or has been selected by the light pen, it is preferable that light is emitted by some indicator light-emitting portions indicating the column position and the row position of the light-emitting portion.

Furthermore, in the present invention, it is preferable that light is emitted by the light-emitting portions in the light-emitting-portion matrix at a predetermined period, the light pen comprises a light-receiving portion that can detect light from any of the light-emitting portions in the light-emitting-portion matrix, and the light-emitting portion that is about to be selected is specified based on a timing of light detected by the light-receiving portion brought close to the light-emitting-portion matrix.

Furthermore, according to the present invention, it is preferable that the period of the light emission is shortened when the light-receiving portion detects light from the light-emitting portion.

Another embodiment of the present invention provides a switching matrix apparatus used for connecting a semiconductor-characteristic measurement apparatus and a device under test, comprising a plurality of input terminals for connection with the semiconductor-characteristic measurement apparatus, a plurality of output terminals for connection with the device under test, a plurality of relay switches that are arranged in a matrix for electrically connecting the input terminals with the output terminals and that are used for opening and closing the electrical connections between the input terminals and the output terminals, a light-emitting-portion matrix in which a plurality of light-emitting portions are arranged in a matrix in correspondence with the respective relay switches, indicator light-emitting portions that are arranged along at least two sides of the light-emitting-portion matrix and that emit light to display indicators of numerals or symbols indicating a position among light-emitting portions in at least one column and one row, and a light pen for selecting a relay switch in cooperation with display of the light-emitting portions in the light-emitting-portion matrix. In the switching matrix apparatus, a combination of opening/closing of the plurality of relay switches is changed and switched with the light pen. In order to facilitate confirmation of the position selected in the light-emitting-portion matrix, light is emitted by a plurality of light-emitting portions in a column of an indicator light-emitting portion that is about to be selected or has been selected with the light pen, and a plurality of light-emitting portions in a row of an indictor light-emitting portion that is about to be selected or has been selected.

Furthermore, according to the present invention, it is preferable that in order to facilitate confirmation of the position selected in the light-emitting-portion matrix, light is emitted by an indicator light-emitting portion in a column that is about to be selected or has been selected with the light pen, an indicator light-emitting portion in a row that is about to be selected or has been selected with the light pen, and a light-emitting portion at intersections between the column and the row in the light-emitting-portion matrix.

Furthermore, in the present invention, it is preferable that in order to distinguish from light emitted for indicating a status of each of the relay switches, the emitted light color, brightness, or flashing pattern of light-emitting portions in a column or row of an indicator light-emitting portion that is about to be selected or has been selected is changed from that of the light emitted for indicating the status, in the light-emitting portions in the light-emitting-portion matrix.

Furthermore, in the present invention, it is preferable that light is emitted by the light-emitting portions in the light-emitting-portion matrix and the indicator light-emitting portions at a predetermined period, the light pen comprises a light-receiving portion that can detect light from any of the indicator light-emitting portions, and the indicator light-emitting portion that is about to be selected is specified based on a timing of light detected by the light-receiving portion brought close to the indicator light-emitting portion.

Furthermore, in the present invention, it is preferable that the period of the light emission is shortened when the light-receiving portion detects light from the indicator light-emitting portion.

According to the present invention, the user can quickly and precisely determine the position of a light-emitting portion that is about to be selected or has been selected and the position of an intended light-emitting portion, on a matrix LED display unit of the switching matrix apparatus. This configuration allows the user to quickly and precisely perform the switching in the switching matrix apparatus used for connecting a plurality of input terminals and a plurality of output terminals.

Furthermore, according to the present invention, the switching matrix apparatus can display the position of a light-emitting portion that is about to be selected or has been selected with the light pen, using LEDs in which the emitted light color, brightness, and flashing pattern are adjusted. This configuration allows the user to simultaneously confirm the position that is about to be selected or has been selected by the user and the status of each relay switch.

Furthermore, in the present invention, the switching matrix apparatus uses an existing LED display unit, and thus no additional cost is incurred.

### BRIEF DESCRIPTION OF THE DRAWINGS

FIG. 1 is a block diagram showing the configuration of a switching matrix apparatus according to an embodiment of the present invention;

FIG. 2 is a block diagram showing the configuration of relay switches of the switching matrix apparatus according to the embodiment of the present invention;

FIG. 3 is a block diagram showing the configuration of the switching matrix apparatus according to the embodiment of the present invention;

FIG. 4 is a perspective view showing the configuration of a light pen according to the embodiment of the present invention;

FIG. 5 is a diagram showing a display mode of a display unit of the switching matrix apparatus according to the embodiment of the present invention;

FIG. 6 is a diagram showing another display mode of the display unit of the switching matrix apparatus according to an embodiment of the present invention;

FIG. 7 is a diagram showing another display mode of the display unit of the switching matrix apparatus according to an embodiment of the present invention;

FIG. 8 is a diagram showing another display mode of the display unit of the switching matrix apparatus according to an embodiment of the present invention; and

FIG. 9 is a block diagram showing another configuration of relay switches of the switching matrix apparatus according to an embodiment of the present invention.

### DETAILED DESCRIPTION OF THE PREFERRED EMBODIMENTS

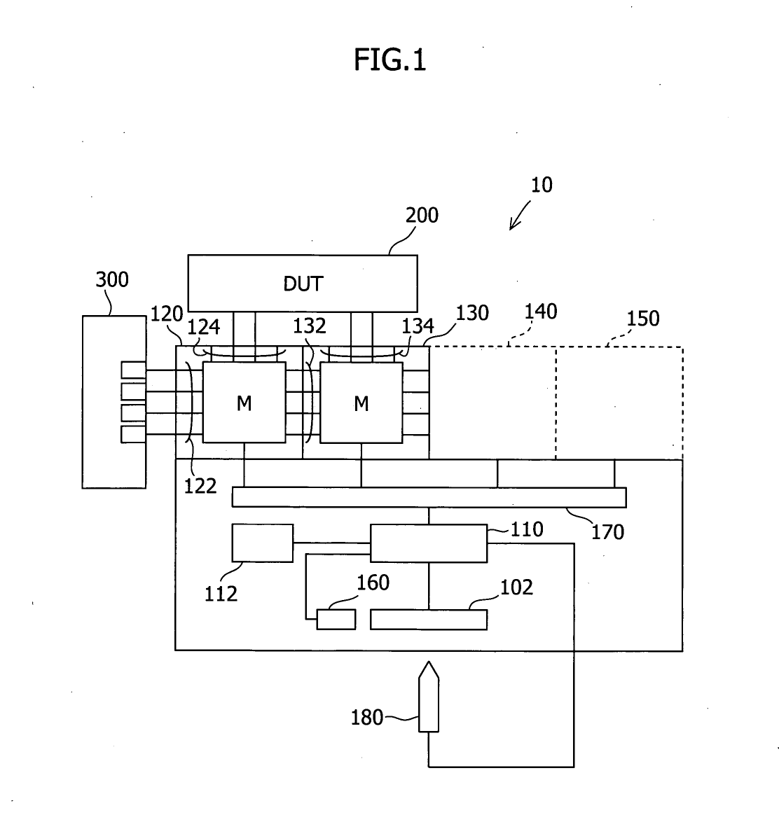

Embodiments of the present invention are described below with reference to the accompanying drawings. FIG. 1 is a block diagram showing the configuration of a switching matrix apparatus 10 according to an embodiment of the present invention. The switching matrix apparatus 10 of this embodiment controls connections between a semiconductor-characteristic measurement apparatus 300, such as an LCR meter, and a device under test (DUT) 200, which is probed by a probe apparatus (not shown) or the like.

The switching matrix apparatus 10 of the embodiment of the present invention includes a first card 120 and a second card 130, which have a plurality of row terminals 122 and 132 and column terminals 124 and 134, respectively. In this case, for simplicity, the row terminals 122 are connected to the semiconductor-characteristic measurement apparatus 300 and the column terminals 124 and 134 are connected to the DUT 200. That is, in the switching matrix apparatus 10, the row terminals 122 serve as a plurality of input terminals for connection with the semiconductor-characteristic measurement apparatus 300 and the column terminals 124 serve as a plurality of output terminals for connection with the DUT 200. The row terminals 132 of the card 130 are connected to, for example, lines linked to the row terminals 122 of the card 120, and the column terminals 134 of the card 130 are connected to the DUT 200.

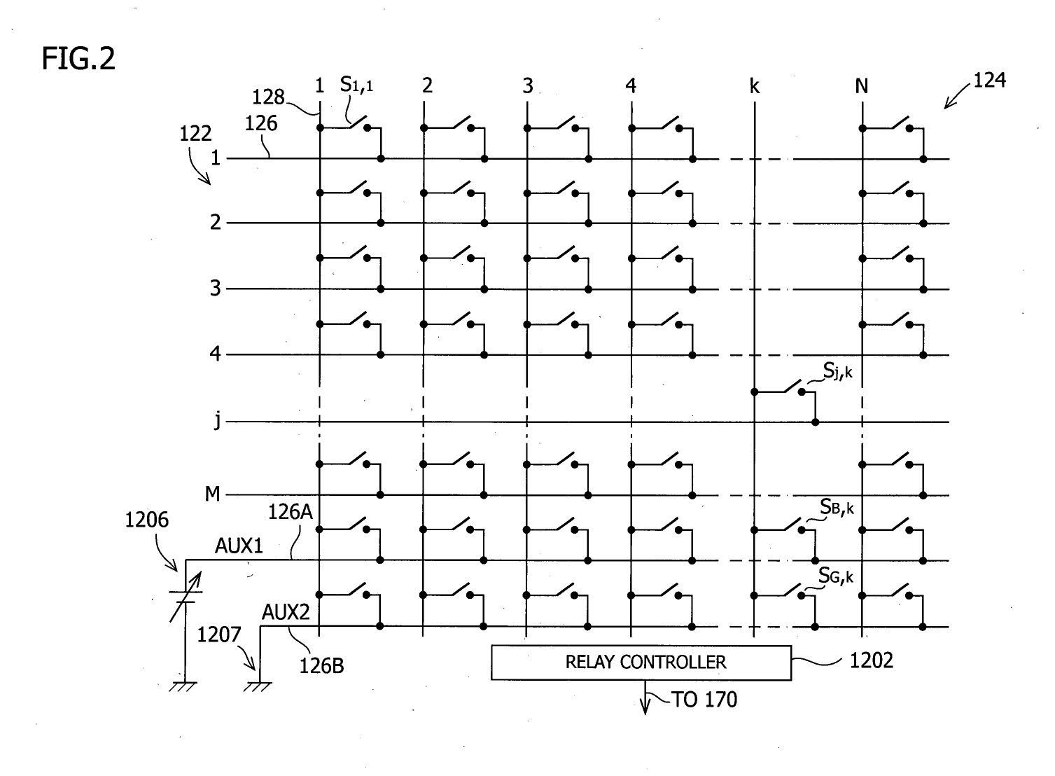

The cards 120 and 130 include a plurality of row lines respectively connected to the plurality of row terminals 122 and 132, and a plurality of column lines respectively connected to the plurality of column terminals 124 and 134. The cards 120 and 130 each include a large number of relay switches in a matrix at the intersections of the row lines and the column lines. In FIG. 1, each matrix of relay switches is shown in an abridged manner as a matrix M. The relay switches open or close the electrical connections between the row lines and the corresponding column lines. Details of the cards 120 and 130 are described below with reference to FIG. 2. The switching matrix apparatus 10 may include one or more card slots into which additional cards, each having a matrix of relay switches, can be connected, and card slots 140 and 150 are shown as an example thereof in FIG. 1.

The switching matrix apparatus 10 of this embodiment of the present invention has a display unit 102 using a light-emitting-portion matrix, that is, LED (light emitting diode) matrix, in which a plurality of light-emitting portions (LEDs, in this specification) are arranged in a matrix in correspondence with the respective relay switches. The switching matrix apparatus 10 of the embodiment of the present invention changes a combination of the opening/closing of the plurality of relay switches to switch a combination of the electrical connections between the plurality of input lines and the plurality of output lines. The display unit 102 displays the open/closed states of the relay switches by letting the corresponding light-emitting portions emit light. Besides LEDs, any light emitter such as a plasma light emitter can be used for the light-emitting portions.

The switching matrix apparatus 10 of this embodiment of the present invention further includes keys 160 for moving a cursor representing a relay switch of interest, a light pen 180 with which a user directly specifies an intended position for the display unit 102, and a memory 112 for storing settings such as a combination of the relay switches. In response to an input from the keys 160 or the light pen 180, a controller 110 controls each of the cards via a bus 170, receives setting information from the cards, and causes the display unit 102 to display the current statuses of the relay switches.

FIG. 2 is a block diagram showing an overview of the configuration of the first card 120. The other card 130 also has a similar configuration. The card 120 has M channels of row terminals 122 (M is an integer from 2 or more), which are connected to respective row input lines 126. The card 120 also has N channels of column terminals 124 (N is an integer from 2 or more), which are connected to respective column output lines 128. As shown in FIG. 2, connection points that define the connections between the row input lines 126 and the column output lines 128 have relay switches S_{j,k} that are arranged in a matrix. In this case, j is an integer of 1 to M indicating the position of each row input line 126 and k is an integer of 1 to N indicating the position of each column output line 128. The relay switches S_{j,k} are controlled independently of each other by a relay controller 1202. The relay controller 1202 communicates with the controller 110 of the switching matrix apparatus 10 via the bus 170.

The row input lines 126 are provided with terminals AUX1 and AUX2 for connecting a bias power source and ground to row terminals 122, relay switches S_{B,k} that can electrically connect a line 126A serving as a bias line, in which a bias voltage source 1206 is connected to the terminal AUX1, to the corresponding column output lines 128, and relay switches S_{G,k} that can electrically connect a line 126B serving as a ground line, in which a ground 1207 is connected to the terminal AUX2, to the corresponding column output lines 128. The lines 126A and 126B allow the column output lines 128 to be selectively connected to the bias voltage source 1206 and the ground 1207. This arrangement allows a line unused for connection with the input terminal and output terminal to be connected to a specific bias voltage or a ground voltage, thereby making it possible to reduce measurement noise and/or signal-settling time.

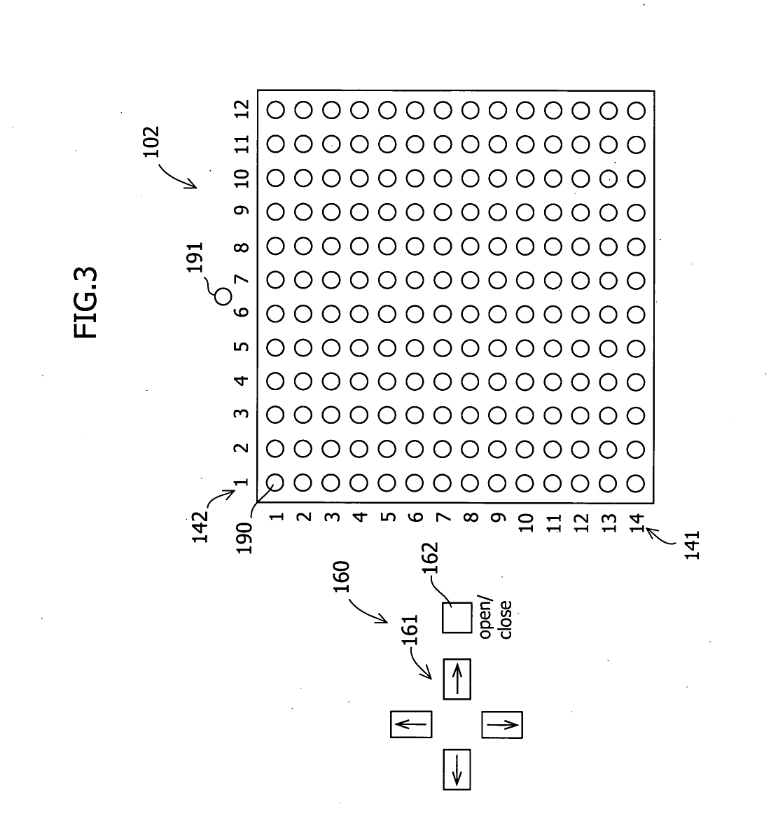

Next, the display of an operation panel on the display unit 102 and the operation of the keys 160 of the switching matrix apparatus 10 according to the embodiment in FIG. 1 is described with reference to FIG. 3. The display unit 102 has an array of LEDs 190. Each of the LEDs 190 distinctively indicates a status of one of the switches S_{j,k} shown in FIG. 2, by emitting light. For example, LEDs corresponding to relay switches that are connected (closed) based on an instruction to connect them from the user emit light, and LEDs corresponding to relay switches that are not connected (open) are turned off.

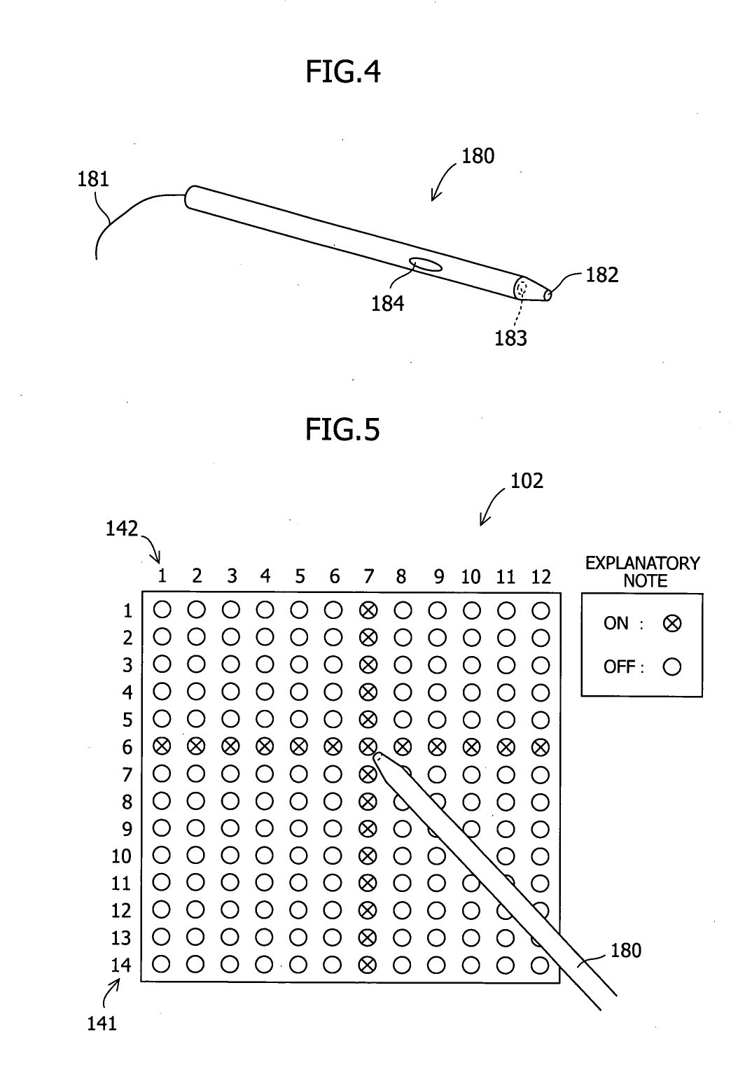

Furthermore, FIG. 4 shows the configuration of the light pen 180 in this embodiment. The light pen 180 has a tip for giving instructions, which incorporates a light-receiving element 183, and a signal line 181 for transmitting an electrical signal generated by receiving light to the controller 110 of the switching matrix apparatus 10. For example, the tip of the light pen 180 incorporates a lens 182, and thus it is possible to limit the incident direction of light that can be detected by the light-receiving element 183 among the light that is incident on the tip of the light pen 180. Thus, the light pen 180 detects only light from this incident direction, and an LED that is about to be selected can be precisely detected even when the LED is not in contact with the tip of the light pen 180.

Then, the controller 110 can turn on all the LEDs in a sequential scanning manner at slightly shifted timing. Furthermore, the controller 110 indicates the position of an LED that is about to be selected in real-time for the user, so that the time interval or the time period to the next scanning can be changed. For example, the controller 110 first performs scanning at a predetermined period (scanning with an interval of two seconds, for example). Next, the controller 110 detects an appropriate event such as a detection of light emitted by any LED with the light-receiving element 183 incorporated in the light pen 180, and shortens the scanning period of LEDs. Accordingly, an LED that is about to be selected by the user can be displayed with a shorter time-lag.

In the switching matrix apparatus in this embodiment of the present invention, a select operation and then a determination operation are performed in order to change a combination of opening/closing of the plurality of relay switches. In particular, in a case in which the light pen 180 is used, the select operation includes a selecting state and a selected state. Herein, the selecting state refers to a state in which the controller 110 can specify an LED that is about to be selected by the user with the light pen 180 even when the light pen 180 is not in contact with the LED, as described above. Further, the selected state refers to a state in which the user has brought the tip of the light pen 180 into contact with any one LED and the LED has been selected. In the selecting state and the selected state, the switching matrix apparatus of the present invention can indicate the position of the specified LED (relay switch), with the LEDs on the display unit 102. In this embodiment, the determination operation in which the relay switch is opened or closed can be performed continuously after the select operation.

In the determination operation, for example, in a case in which a switch is provided on the tip of the light pen 180, the user can determine opening/closing of the relay switches by bringing the tip of the light pen 180 into contact with any LED and by pressing the switch on the tip of the light pen 180. Furthermore, as another example, in a case in which a switch 184 is provided on the body of the light pen 180, the user can determine an LED that is pointed at with the light pen 180, by activating the switch 184. Furthermore, the determination operation is performed, for example, when the user presses an open/close key 162 or presses again the switch on the tip or the body of the light pen 180. The switching matrix apparatus of the present invention can be configured such that a relay switch corresponding to an LED that has been selected directly before the determination operation turns from the current open/closed state to the opposite open/closed state, with this determination operation.

Differently from the above-described example, in the switching matrix apparatus according to another embodiment of the present invention, it is possible to perform the determination operation for an LED that is about to be selected or has been selected, or to change the on-period for scanning the LEDs, based on another event or operation. For example, in the case in which the switch 184 is provided on the body of the light pen 180, it is possible to shorten the on-period for scanning when the user presses down the switch 184 or operates the open/close key 162 provided on the apparatus main unit, for example. Furthermore, it is also possible to select each relay switch when the user releases the switch 184 or operates again the open/close key 162. A configuration is also possible in which the determination operation is performed continuously without any operation when an LED is selected with the operation of specifying the LED that is pointed at with the light pen 180.

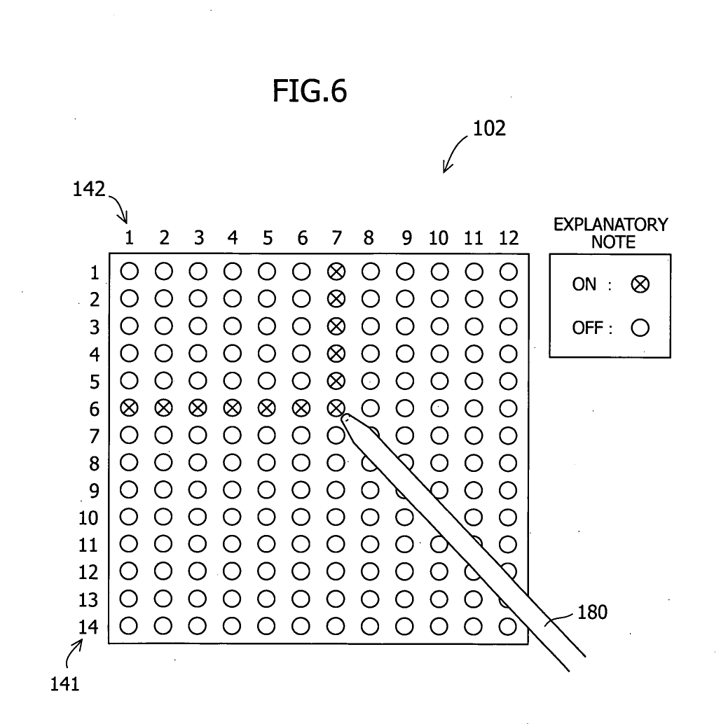

Next, FIG. 5 shows a display mode displayed by LEDs of the display unit 102. A column display portion 142 and a row display portion 141 are provided on the edge of the display unit 102. The column display portion 142 and the row display portion 141 are indicators displayed with integers or alphabets that indicate the positions in rows and columns of the array of the LEDs on the display unit 102. When the user is about to select or has selected an intended LED using the light pen 180, the display unit 102 in this display mode displays cursors by turning on, in the form of a cross, the LED pointed at with the light pen 180 as the center and other LEDs in the column and row including the LED. As a modified example of this display mode, the switching matrix apparatus 10 can display cursors in the form of an L on the display unit 102 by turning on the LED pointed at with the light pen 180 as the starting point and other LEDs lined up toward the column display portion 142 and the row display portion 141, as shown in FIG. 6. Thus, with the switching matrix apparatus 10 of this embodiment, the user can quickly and precisely determine the position that is about to be selected or has been selected with a light pen 180 on the display unit 102.

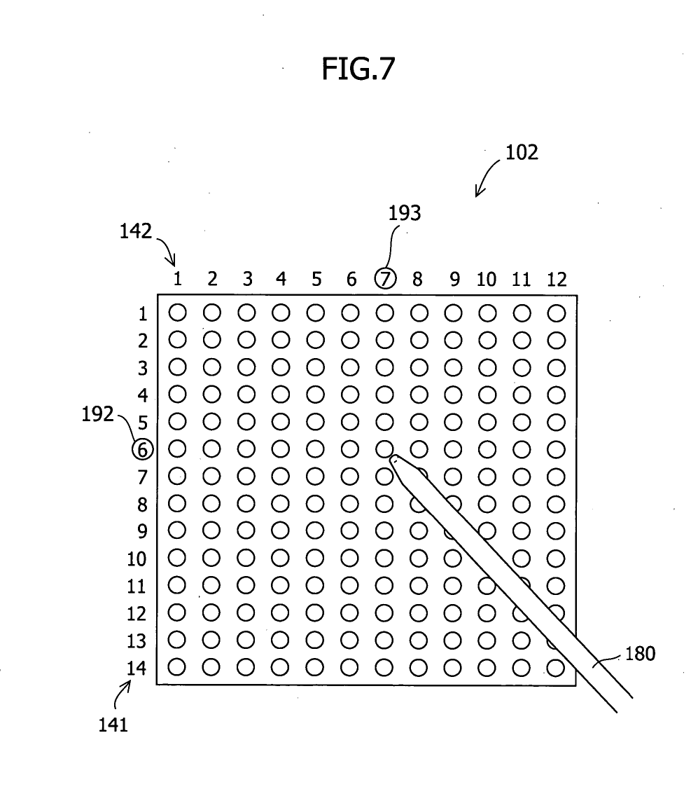

Next, FIG. 7 shows a display mode of the display unit 102 in the switching matrix apparatus 10 according to another embodiment of the present invention. The display unit 102 is provided with a column display portion 142 and a row display portion 141 that can emit light at edges of the columns and rows. When the user is about to select or has selected an intended position using the light pen 180, a column number 192 and a row number 193 corresponding to the intended position are turned on. These numbers are configured such that they can be seen as indicator light-emitting portions in which the letters themselves emit light, for example, by arranging light-emitting portions of LEDs on the rear face and by using a transparent panel for the letter portions of the numbers on the front face.

In another embodiment of the present invention, when the user uses cursor keys 161 shown in FIG. 3 to handle the position of a target relay switch, and uses the open/close key 162 to input the switching of connection/disconnection of the target relay switch or uses the light pen 180 to input the connection/disconnection, the switching matrix apparatus 10 in this embodiment can change the emitted light color, brightness, or flashing pattern of LEDs serving as a cursor, in accordance with the status of the relay switch, in order to clearly and simultaneously indicate the position of the LED that is about to be selected or has been selected and the status of the corresponding relay switch. It should be noted that the term “status” herein refers to information that is used by the user for operating the switching matrix apparatus of the present invention, such as whether the relay switch is open or closed, whether or not it can be controlled by the user, whether or not it is connected to a specific line such as a ground line, or whether or not the user has performed the determination operation on the state of the relay switch.

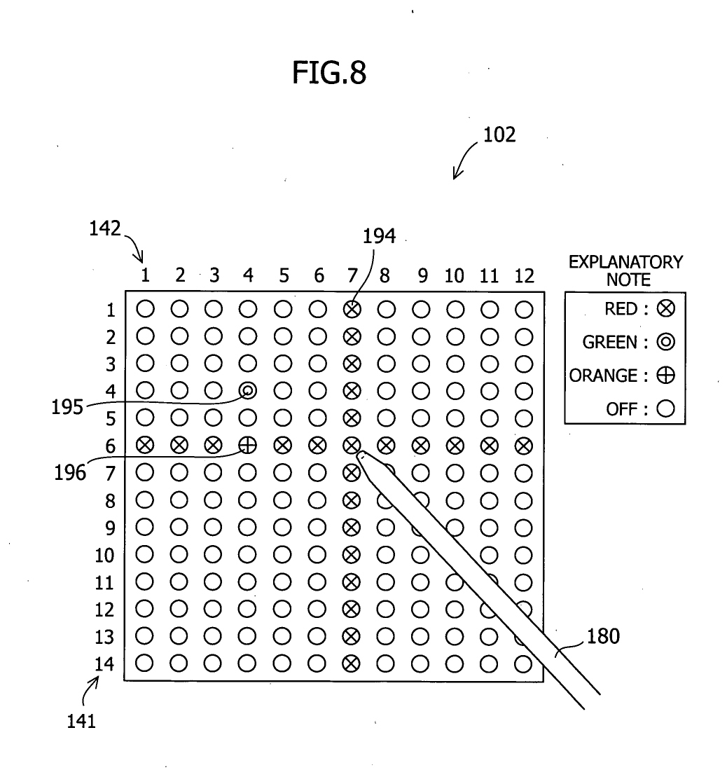

FIG. 8 shows a manner for distinguishing other information from this status. In FIG. 8, when the states of LEDs are specified through a combination of whether the statuses of relay switches are open or closed and whether or not the corresponding LEDs are on cross cursors, a red light 194 is turned on for an LED that is open and is on a cross cursor; a green light 195 is turned on for an LED that is closed and is not on a cross cursor; an orange light 196 is turned on for an LED that is open and is on a cross cursor; and the light is turned off for LEDs that are open and are not on a cross cursor, in this embodiment. With this arrangement, the user can easily determine whether each relay switch is open or closed by taking a look at the emitted light color, namely, the red 194 or the orange 196 even when the relay switch is on a cross cursor.

The switching matrix apparatus 10 of this embodiment has an LED 191 (FIG. 3) that indicates the states (normal, installed/not installed, and malfunction, for example) of each card. This LED may be used to indicate the states of each card such that, for example, light turned off indicates a state in which the card is not installed, red light turned on indicates that a diagnosis process has found a malfunction in the card, and green light turned on indicates a state in which the card can be properly used.

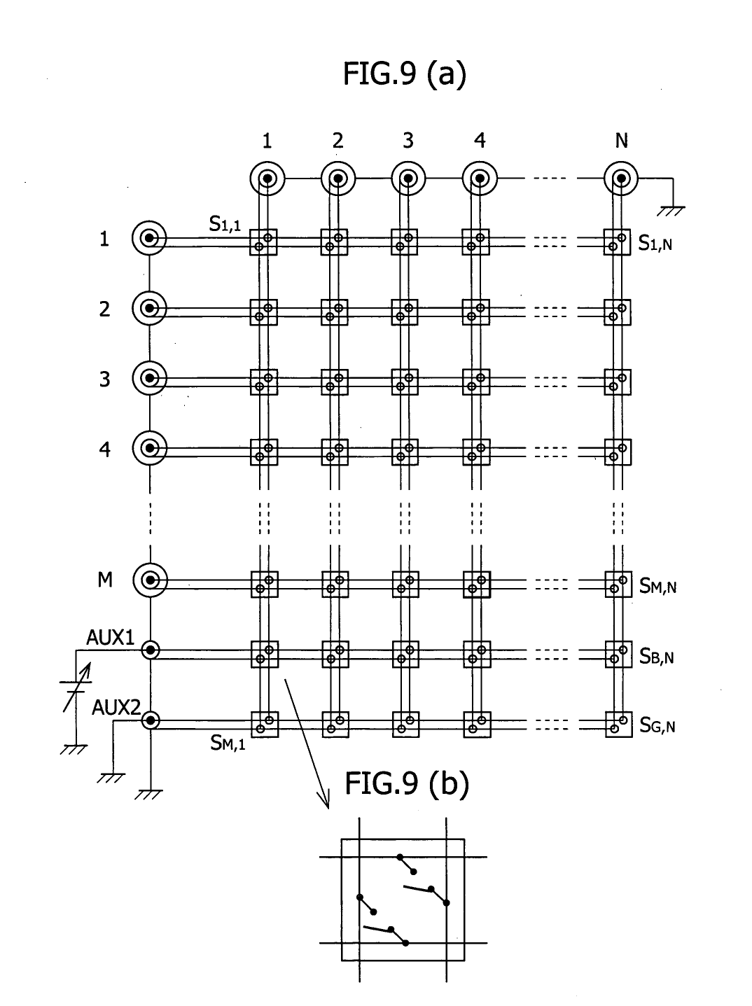

FIG. 9 is a block diagram showing an overview of the configuration of each card when triaxial connectors are used for the input terminals and output terminals, as a modification of the switching matrix apparatus of the embodiment. As shown in part (a) in FIG. 9, for the input and output terminals other than the input terminals AUX1 and AUX2, triaxial connectors in which a signal line, a guard line, and a common (ground) line are connected in that order from the core-line side are arranged. The input lines and output lines are each constituted by a line having a signal line and a guard line. The signal lines and the guard lines of the input lines and the output lines are connected via matrix relay switches (see part (b) in FIG. 9) that interconnect the signal lines and the guard lines of the input lines and the output lines.

In the switching matrix apparatus according to another embodiment of the present invention, when the light pen is used to select an indicator light-emitting portion of the column display portion 142 and an indicator light-emitting portion of the row display portion 141, a selected LED is specified based on the column and row, and a combination of opening/closing of a relay switch corresponding to the selected LED can be changed. In the switching matrix apparatus in this embodiment, the controller 110 can turn on LEDs arranged, for example, on the rear faces of the column indicators and the row indicators in a sequential scanning manner, similarly to the LEDs in the light-emitting-portion matrix. In such an embodiment, when the tip of the light pen 180 is brought into contact with an indicator light-emitting portion, it is possible to let the LED of the indicator light-emitting portion or the LEDs, in the light-emitting-portion matrix, corresponding to the column or row of the indicator emit light. Furthermore, even when the light pen 180 is not in contact with an indicator light-emitting portion, it is possible to let the LED of the indicator light-emitting portion or the LEDs, in the light-emitting-portion matrix, corresponding to the column or row of the indicator emit light. Further, in the switching matrix apparatus of this embodiment, for example, when the tip of the light pen is brought into contact with any indicator light-emitting portion of the column display portion 142, it is possible to keep a state in which the column is selected, by letting the LED of the indicator emit light or flash, until the tip of the light pen is next brought into contact with an indicator light-emitting portion for any row. Subsequently, when the light pen is brought into contact with an indicator light-emitting portion for any row, the row is selected and a relay switch corresponding to the LED specified based on the selected column and the selected row is selected. Then, the opening/closing of the relay switch can be determined by operating, for example, the switch 184 on the body of the light pen or the open/close key 162. A configuration is also possible in which the opening/closing is determined continuously without any operation when the light pen is used to select an indicator light-emitting portion for the column and an indicator light-emitting portion for the row.

In this embodiment, a setting is possible in which when the light pen is in contact with any column indicator, only the LED of the column indicator emits light, in which when the light pen is next in contact with any row indicator, only the LED of the row indicator emits light, and in which then the LEDs in the light-emitting-portion matrix of the selected column and row emit light. At that time, it is possible to let only the LED at the intersections of the selected column and row emit light, or it is possible to let the emitted light color or brightness or the like of the LED at the intersections be different from that of the other LEDs emitting light. It is also possible to determine opening/closing of a relay switch by bringing the light pen into contact with the LEDs in the light-emitting-portion matrix. Furthermore, in a similar manner to that described above, it is possible to determine opening/closing of relay switches continuously without any operation when the LEDs, in the light-emitting-portion matrix, corresponding to the column and row of the selected indicators emit light.

In the switching matrix apparatus of another embodiment of the present invention, a setting is possible in which LEDs in the light-emitting-portion matrix emit dimmer light than indicator LEDs, emit light with different color, or flash, for example, in order to distinguish light emitted by the indicator LEDs and light emitted by the LEDs in the light-emitting-portion matrix.

Embodiments of the present invention have been described above, but the present invention is not limited to the above-described embodiments. Various types of changes, alternations, and combinations are possible based on the technical concept of the present invention.

We claim:

1. A switching matrix apparatus used for connecting a semiconductor-characteristic measurement apparatus and a device under test, comprising:
a plurality of input terminals for connection with the semiconductor-characteristic measurement apparatus;
a plurality of output terminals for connection with the device under test;
a plurality of relay switches that are arranged in a matrix for electrically connecting the input terminals with the output terminals, and that are used for opening and closing the electrical connections between the input terminals and the output terminals;
a light-emitting-portion matrix in which a plurality of light-emitting portions are arranged in a matrix in correspondence with the respective relay switches, and in which numerals or symbols indicating a position among the light-emitting portions in at least one column and one row are displayed along at least two sides of the light-emitting portions arranged in a matrix; and
input means for selecting a relay switch in cooperation with display of the light-emitting portions in the light-emitting-portion matrix,
wherein a combination of the electrical connections between the plurality of input terminals and the plurality of output terminals is switched by changing a combination of opening/closing of the plurality of relay switches, and
wherein in order to facilitate confirmation, based on the numerals or symbols, of a position by column and row of a light-emitting portion selected by the input means in the light-emitting-portion matrix, light is emitted by at least one other light-emitting portion relating to the selected light-emitting portion.

2. The switching matrix apparatus according to claim 1, wherein when a light-emitting portion in the light-emitting-portion matrix is selected by the input means, light is emitted by at least one or more other light-emitting portions of the column and the row comprising the light-emitting portion, in the light-emitting-portion matrix.

3. The switching matrix apparatus according to claim 1, wherein when a light-emitting portion in the light-emitting-portion matrix is selected by the input means, light is emitted by at least one light-emitting portion located between the selected light-emitting portion and the numerals or symbols, among other light-emitting portions in the column and the row comprising the light-emitting portion, with in the light-emitting-portion matrix.

4. The switching matrix apparatus according to claim 1,
wherein in order to distinguish from light emitted for indicating a status of each of the relay switches, an emitted light color, brightness, or flashing pattern of the selected light-emitting portion is changed from that of the light emitted for indicating the status, in the light-emitting portions in the light-emitting-portion matrix.

5. A switching matrix apparatus used for connecting a semiconductor-characteristic measurement apparatus and a device under test, comprising:
a plurality of input terminals for connection with the semiconductor-characteristic measurement apparatus;
a plurality of output terminals for connection with the device under test;
a plurality of relay switches that are arranged in a matrix for electrically connecting the input terminals with the output terminals, and that are used for opening and closing the electrical connections between the input terminals and the output terminals;
a light-emitting-portion matrix in which a plurality of light-emitting portions are arranged in a matrix in correspondence with the respective relay switches;
indicator light-emitting portions that are arranged along at least two sides of the light-emitting-portion matrix, and that emit light to display numerals or symbols indicating position among the light-emitting portions in at least one column and one row; and
input means for selecting a relay switch in cooperation with display of the light-emitting portions in the light-emitting-portion matrix,
wherein a combination of the electrical connections between the plurality of input terminals and the plurality of output terminals is switched by changing a combination of opening/closing of the plurality of relay switches, and
wherein in order to facilitate confirmation, based on the numerals or symbols, of a position by column and row of a light-emitting portion selected by the input means in the light-emitting-portion matrix, light is emitted by the indicator light-emitting portions.

6. The switching matrix apparatus according to claim 1, wherein the input means is a light pen.

7. The switching matrix apparatus according to claim 1, wherein the input means is cursor keys.

8. A switching matrix apparatus used for connecting a semiconductor-characteristic measurement apparatus and a device under test, comprising:
a plurality of input terminals for connection with the semiconductor-characteristic measurement apparatus;
a plurality of output terminals for connection with the device under test;
a plurality of relay switches that are arranged in a matrix for electrically connecting the input terminals with the output terminals, and that are used for opening and closing the electrical connections between the input terminals and the output terminals;
a light-emitting-portion matrix in which a plurality of light-emitting portions are arranged in a matrix in correspondence with the respective relay switches, and in which numerals or symbols indicating a position among the light-emitting portions in at least one column and one row are displayed along at least two sides of the light-emitting portions arranged in a matrix; and
a light pen for selecting a relay switch in cooperation with display of the light-emitting portions in the light-emitting-portion matrix,
wherein a combination of opening/closing of the plurality of relay switches is changed and switched with the light pen, and
wherein in order to facilitate confirmation, based on the numerals or symbols, of a position by column and row of a light-emitting portion that is about to be selected or has been selected with the light pen in the light-emitting-portion matrix, light is emitted by at least one other light-emitting portion relating to the light-emitting portion that is about to be selected or has been selected.

9. The switching matrix apparatus according to claim 8, wherein when a light-emitting portion in the light-emitting-portion matrix is about to be selected or has been selected with the light pen, light is emitted by at least some other light-emitting portions of the column and the row comprising the light-emitting portion, in the light-emitting-portion matrix.

10. The switching matrix apparatus according to claim 8, wherein when a light-emitting portion in the light-emitting-portion matrix is about to be selected or has been selected with the light pen, light is emitted by at least some light-emitting portions between the light-emitting portion that is about to be selected or has been selected and the numerals or symbols, among the other light-emitting portions of the column and the row comprising the light-emitting portion, in the light-emitting-portion matrix.

11. The switching matrix apparatus according to claim 8, wherein in order to distinguish from light emitted for indicating a status of each of the relay switches, an emitted light color, brightness, or flashing pattern of the light-emitting portion that is about to be selected or has been selected is changed from that of the light emitted for indicating the status, in the light-emitting portions in the light-emitting-portion matrix.

12. A switching matrix apparatus used for connecting a semiconductor-characteristic measurement apparatus and a device under test, comprising:
a plurality of input terminals for connection with the semiconductor-characteristic measurement apparatus;
a plurality of output terminals for connection with the device under test;
a plurality of relay switches that are arranged in a matrix for electrically connecting the input terminals with the output terminals, and that are used for opening and closing the electrical connections between the input terminals and the output terminals;
a light-emitting-portion matrix in which a plurality of light-emitting portions are arranged in a matrix in correspondence to the respective relay switches;
indicator light-emitting portions that are arranged along at least two sides of the light-emitting-portion matrix, and that emit light to display numerals or symbols indicating a position among the light-emitting portions in at least one column and one row; and
a light pen for selecting a relay switch in cooperation with display of the light-emitting portions in the light-emitting-portion matrix,
wherein a combination of opening/closing of the plurality of relay switches is changed and switched with the light pen, and
wherein in order to facilitate confirmation, based on the numerals or symbols, of a position by column and row of a light-emitting portion that is about to be selected or has been selected with the light pen in the light-emitting-portion matrix, light is emitted by the indicator light-emitting portions.

13. The switching matrix apparatus according to claim 8,
wherein light is emitted by the light-emitting portions in the light-emitting-portion matrix at a predetermined period,
wherein the light pen comprises a light-receiving portion that can detect light from any of the light-emitting portions in the light-emitting-portion matrix, and
wherein the light-emitting portion that is about to be selected is specified based on a timing of light detected by the light-receiving portion brought close to the light-emitting-portion matrix.

14. The switching matrix apparatus according to claim 13, wherein the period of the light emission is shortened when the light-receiving portion detects light from the light-emitting portion.

15. A switching matrix apparatus used for connecting a semiconductor-characteristic measurement apparatus and a device under test, comprising:
a plurality of input terminals for connection with the semiconductor-characteristic measurement apparatus;
a plurality of output terminals for connection with the device under test;
a plurality of relay switches that are arranged in a matrix for electrically connecting the input terminals with the output terminals, and that are used for opening and closing the electrical connections between the input terminals and the output terminals;
a light-emitting-portion matrix in which a plurality of light-emitting portions are arranged in a matrix in correspondence with the respective relay switches;
indicator light-emitting portions that are arranged along at least two sides of the light-emitting-portion matrix, and that emit light to display numerals or symbols indicating a position among the light-emitting portions in at least one column and one row; and
a light pen for selecting a relay switch in cooperation with display of the light-emitting portions in the light-emitting-portion matrix,
wherein a combination of opening/closing of the plurality of relay switches is changed and switched with the light pen, and
wherein in order faciliate confirmation of a position selected in the light-emitting-portion matrix, light is emitted by a plurality of light-emitting portions in a column of an indicator light-emitting portion that is about to be selected or has been selected with the light pen, and a plurality of light-emitting portions in a row of an indictor light-emitting portion that is about to be selected or has been selected.

16. The switching matrix apparatus according to claim 15, wherein in order to facilitate confirmation of a position selected in the light-emitting-portion matrix, light is emitted by an indicator light-emitting portion in a column that is about to be selected or has been selected with the light pen, an indicator light-emitting portion in a row that is about to be selected or has been selected with the light pen, and a light-emitting portion at intersections between the column and the row in the light-emitting-portion matrix.

17. The switching matrix apparatus according to claim 15, wherein in order to distinguish from light emitted for indicating a status of each of the relay switches, an emitted light color, brightness, or flashing pattern of light-emitting portions in a column or row of an indicator light-emitting portion that is about to be selected or has been selected is changed from that of the light emitted for indicating the status, in the light-emitting portions in the light-emitting-portion matrix.

18. The switching matrix apparatus according to claim 15,
wherein light is emitted by the light-emitting portions in the light-emitting-portion matrix and the indicator light-emitting portions at a predetermined period,
wherein the light pen comprises a light-receiving portion that can detect light from any of the indicator light-emitting portions, and
wherein the indicator light-emitting portion that is about to be selected is specified based on a timing of light detected by the light-receiving portion brought close to the indicator light-emitting portion.

19. The switching matrix apparatus according to claim 18, wherein the period of the light emission is shortened when the light-receiving portion detects light from the indicator light-emitting portion.
